(19) United States
(12) Patent Application Publication
(10) Pub. No.: US 2005/0045256 A1
(43) Pub. Date: Mar. 3, 2005

(54) Wheel and a Wheel Rim

(76) Inventor: Claudio Corte, Limeira (BR)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/494,165

(22) PCT Filed: Mar. 7, 2002
(86) PCT No.: PCT/BR02/00034

(30) Foreign Application Priority Data
Oct. 31, 2001 (BR) PI 0104931-3

(51) Int. Cl. B60C 17/00

(52) U.S. Cl. 152/152

(57) ABSTRACT

A wheel, especially for use on vehicles, is provided comprising a substantially circular rim for fixation of an inflatable tire, and at least one support ring, the support ring being substantially concentric with and being an integral part of the rim. The present invention has the advantage of enabling one to drive a vehicle equipped with the wheels disclosed herein with control, and without any risk of unexpected loss of control and without the wheel or the tire being damaged. Also, one can avoid the discomfort and danger of having to change the tire in places with circulation of vehicles.

### CROSS-REFERENCE TO RELATED APPLICATIONS

This application is a U.S. National Phase application of PCT Application No. PCT/BR02/00034, filed Mar. 7, 2002, which was published in English on May 8, 2003, and which claims priority to Brazilian Application No. PI0104931-3, filed Oct. 31, 2001.

### BACKGROUND OF THE INVENTION

1. Field of the Invention

The present invention relates to a wheel, especially for use on automotive vehicles, and to a wheel rim for a wheel.

2. Description of Related Art

Punctures in tires of automotive vehicles such as cars or commercial vehicles (utility vehicles, buses, trucks and their trailers, etc.) have been trouble ever since inflatable tires were invented. Tire punctures expose the driver to (i) accident risks if the tire empties suddenly while the vehicle is moving at high speed, a situation in which driving control over the vehicle may be lost, and (ii) a discomfort situation due to the need for changing the punctured tire, with the need to use a jack for lifting the vehicle, the wrench for loosening the screws, placing the spare tire, etc. In addition, changing of a tire on a highway shoulder or on the streets is very dangerous, because the chance of the vehicle and its driver being run into by another vehicle at high speed is considerable.

Since preventing tire puncture is something almost impossible, due to the existence of piercing objects and surfaces on highways, one has tried to develop systems that could enable one to drive in safety with a pressure less tire, without bead detachment, a situation in which the tire disengages from the wheel rim, or permanent damage occurs to either or both of them.

In view of this, one has developed proposals of wheel with tires that could run without pressure, comprising a wheel rim provided with a belt of deformable material, positioned concentrically thereto in its external region, and configured in such a way that it would have an outer diameter larger than the maximum outer diameter of the rim. In this way, when the tire is emptied of air, in spite of the tendency of the tire to deform under the weight of the vehicle, its inner surface touched the outer surface of the belt. The system was dimensioned so that the height of the belt would cause the deformation undergone by the tire to be minor, thus enabling one to drive the vehicle in safety (provided that a speed higher than 80 km/h would not be reached). This system presented efficient results, enabling one to drive a vehicle with a pressure less tire. However, it was necessary to place and fix the belt of deformable material, which would case a high wheel-manufacture cost. Two inventions based on this system are described in patents U.S. Pat. No. 4,922,981, corresponding to Brazilian patent PI 8805513, and U.S. Pat. No. 5,749,982, corresponding to Brazilian patent PI 9408279-0.

Further, one developed a system comprising a wheel especially designed for adaptation of an equally special tire, so that the tire remains rigidly fixed to the wheel, thus avoiding bead detachment. The wheel also has a belt of elastomeric material (preferably alveolate) to ensure greater flexibility, to offer “flexible temporary support”. The vehicle equipped with this system includes sensors for monitoring the tire pressure, so as to inform the driver of drop in pressure in the tire of a wheel of the vehicle by way of a sound/light signal.

The need for special wheel and tires, the belt of a polymeric material and the system of monitoring tire pressure have made this system unfeasible for implementation in a large number of vehicles due to its high cost. In addition, this specific wheel, independently of being manufactured from stamped steel or a light-metal alloy, has a weight at least 25% higher than the conventional wheel, so that the suspension of the vehicle has to be reinforced in order to function well with this considerable increase in the weight of the wheel/tire assembly, which is a mass that is not suspended by the suspension assembly.

Another drawback that extremely limits the use thereof is the need for special machines and tools for mounting and dismounting these tires, which limits, at least in the short and middle term, the number of establishments capable of making the repair of the punctured tire.

Catalogs of tire manufacturers illustrate systems in which the wheel comprises a rim and a disc fixed at the middle portion of this rim, which enables one to use a special tire, the bead of which (the part that is fixed to the wheel rim) is associated with the rim on the inner surface thereof, thus avoiding bead detachment. In this case, the surface of the rim itself ends up functioning as a tire-support belt, but this only occurs after the whole geometry of the assembly has been altered, the rim being “further inwards” with respect to the tire.

However, this configuration also needs specifically developed tires and wheels, as well as specific tools for dismounting it, which limits the possibility of implementing it on a large scale. Finally, the aesthetic result of the thus configured wheel is not attractive, causing more restrictions to its use.

Document EP 0 140 074 reveals a vehicle wheel on which can be mounted a pneumatic tire having a support member disposed axially inwardly of the seating surfaces of the rim. Due to the existence of the support member, it is possible to guarantee control of a vehicle when it is running with a flat tire (also called pressure less condition). Axially inwardly from the tire seating surfaces, the rim is provided with a support member having a diameter which is greater than the diameter of rim's flanges. In a first embodiment, the support member is substantially annular and has a “U” shaped cross section, being welded to the rim. The second embodiment, on the other hand, is different since the support member is “T” shaped and is an integral part of the rim. However, it is difficult to manufacture a rim thus configured unless you machine the support member, increasing its manufacturing costs.

Document EP 0 679 541 refers to a light-weight, low-cost and easy-to-manufacture rim for use with a tire assembly, capable of realizing safe and stable high speed travel with a flat tire and an extended continuous travel distance. The rim thus revealed comprises a pair of bead seats along which beads of a tire are engageably positioned, a pair of flanges being formed along each outer side of the pair of bead seats and a support section, both sides thereof being integrally connected respectively to both inner sides of the pair of bead seats, and being provided so as to project radially outside relative to the bead seats. The support section supports a crown portion of a tire from the inside thereof when the internal pressure of the tire drops.

One aspect of the present invention is to provide a wheel for use with a tire which enables one to drive a vehicle having one or more pressure less tires, without bead detachment occurring (a situation in which the tire disengages from the wheel rim) and without permanent damages to either or both of them. The wheel should not have a belt of an elastomeric material since the latter presents an additional manufacture cost.

Another aspect of the present invention is to provide a wheel rim for use on said wheel.

### BRIEF SUMMARY OF THE INVENTION

The present invention is achieved by a wheel, particularly for use on vehicles, provided with a substantially circular rim for fixation of an inflatable tire, the rim also comprising at least one support ring that is concentric with, and being an integral part of, the rim. The support ring comprises a bore for installation of a tire-inflating control valve.

Also, the present invention is achieved by a substantially circular wheel rim for fixation of an inflatable tire, comprising at least one support ring substantially concentric with, and being an integral part of, the rim. The support ring comprises a bore for installation of a tire-inflating control valve.

The present invention has an advantage of enabling a vehicle equipped with the wheels disclosed here to be driven with total safety, when a tire empties, without any risk of unexpected loss of control and without the wheel and the tire being damaged. In addition, it becomes possible to go on driving with the pressure less tire and only to change it at a safe place, or else to go directly to a tire-fixing workshop, thus avoiding the discomfort and danger of changing a tire at places with circulation of vehicles.

### BRIEF DESCRIPTION OF THE SEVERAL VIEWS OF THE DRAWING(S)

The present invention will now be described in greater detail with reference to an embodiment represented in the drawings, wherein the figures show:

FIG. 1 is a cross-section view of an end region of a first embodiment of the wheel of the present invention, without the tire;

FIG. 2 is a cross-section view of an end region of the first embodiment of the wheel of the present invention, with the tire on;

FIG. 3 is a cross-section view of the wheel rim of the wheel of the present invention, without the tire;

FIG. 4 is a side view of the rim illustrated in FIG. 3;

FIG. 5 is a cross-section view of an end view of a second embodiment of the wheel of the present invention, with the tire on;

FIG. 6 is a cross-section view of an end region of a third embodiment of the wheel of the present invention, with the tire on;

FIG. 7 is a cross-section view of an end region of a fourth embodiment of the wheel of the present invention, with the tire on; and

FIG. 8 is a cross-section view of an end region of a fifth embodiment of the wheel of the present invention, with the tire on.

### DETAILED DESCRIPTION OF THE INVENTION

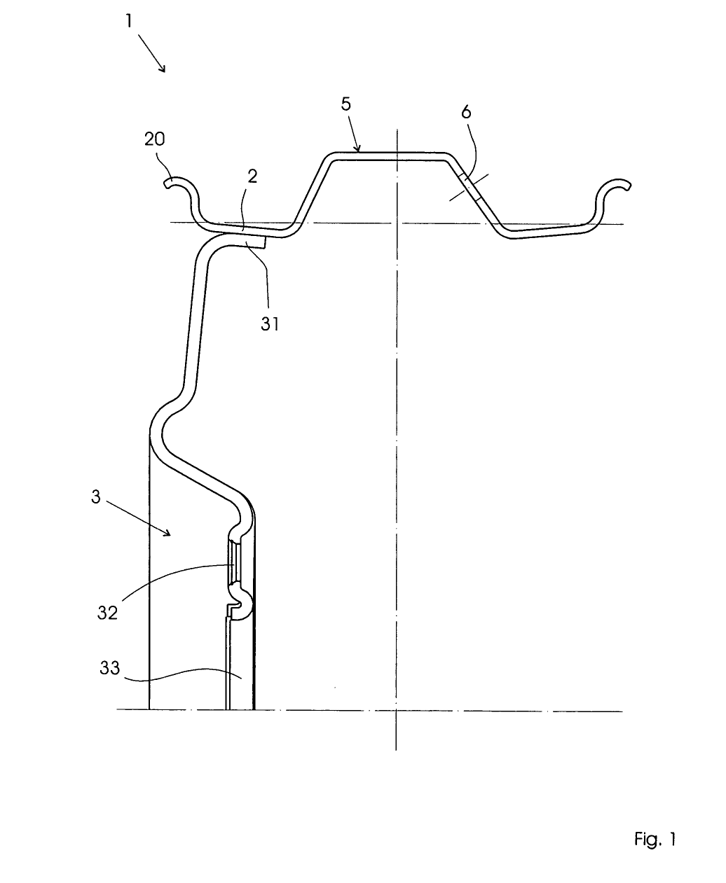

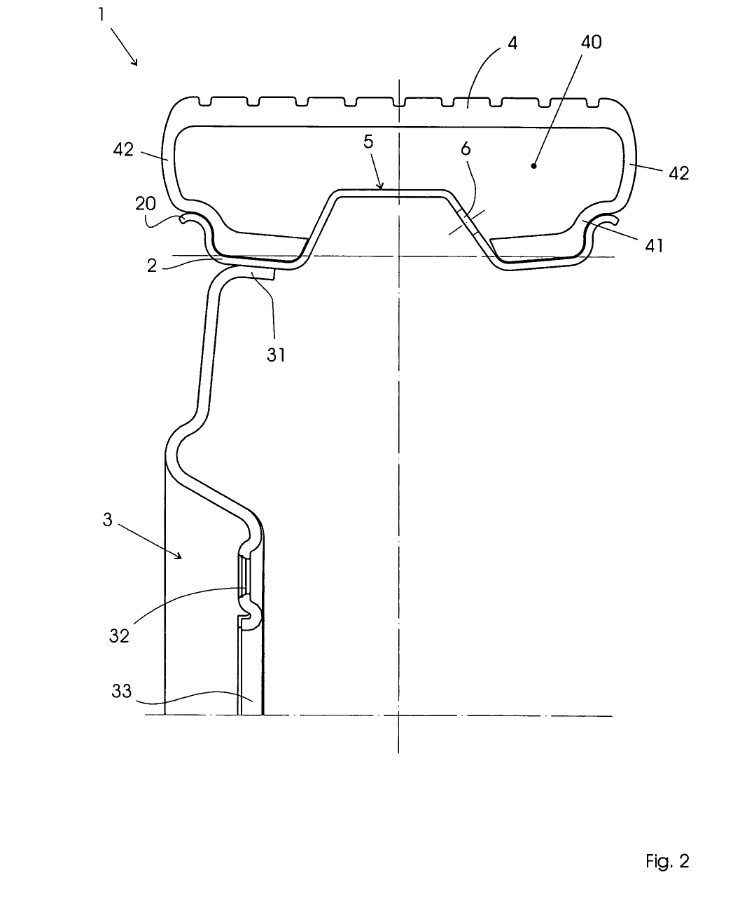

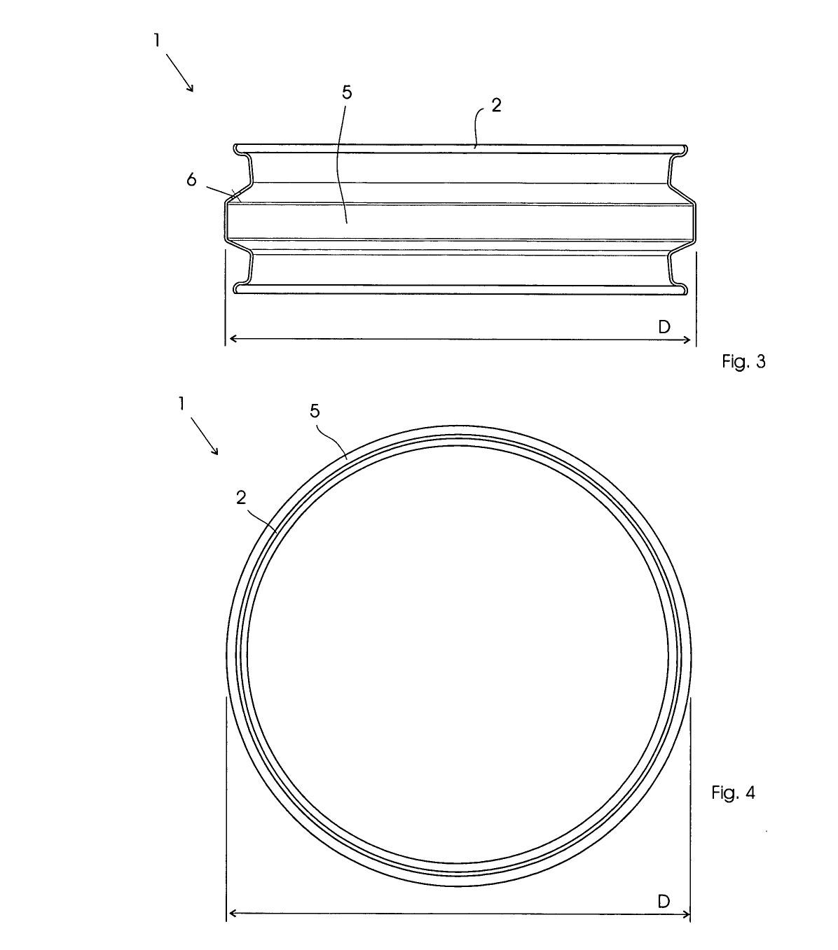

According to a preferred embodiment and as can be seen in FIG. 1, the wheel 1 of the present invention comprises a cylinder-shaped rim 2 and a substantially circular disc 3 associated to each other, both of them preferably made of steel by a lamination process. The disc 3 has its free end portion 31 associated to an intermediate internal portion of the rim 2, that is to say, the surface facing the inside of the wheel 1, not to the tire 4. Optionally, there may be a wheel configuration 1 in which the end portion of the rim 2 is associated to the disc 3. Alternatively, one may also conceive a wheel in which the rim 2 and the disc 3 are a single piece, as for example a wheel manufactured by fusing a metal alloy in a mold.

The wheel disc 3 has axial fixation bores 32 for fixing the wheel 1 to a hub of a vehicle axle (not shown), as well as a central axial bore 33 for accommodating the end of vehicle axle (not shown), when the wheel 1 is installed on the vehicle. As a general rule, the fixation bores 32 are radially arranged around the geometric longitudinal axis of the wheel 1.

Optionally, the disc 3 presents further a passer-by bore (not shown) for ventilation of the brake system of the vehicle and for greater elaboration of the wheel 1 draw.

The inflatable tire 4, hereinafter called merely tire 4, is mounted on the wheel rim 2, which comprises an inner surface facing the center of the circumference defined by it and an outer surface, so that the external region of the tire bore, or bead 41, is associated to the inner surface of the rim 2, in an end portion 20 that has a curvature designed to prevent side movement of the tire 4. Optionally, one may provide a wheel 1 in which this end having a curvature is an integral part of the wheel disc 3, not of the rim 2, with identical objectives and results achieved.

Whatever the embodiment of the present invention, the wheel 1 has a support ring 5 that is an integral part of the rim 2, designed for enabling one to drive the vehicle in safety, even in the event of a sudden loss of pressure of the tire 4, without the latter or even the wheel 1 being damaged, as explained later.

As already known, the rim 2 is manufactured from a piece of laminated, welded and balanced steel, having a cylindrical shape. In this way, the rim 2 may have a cross-section of any desired shape.

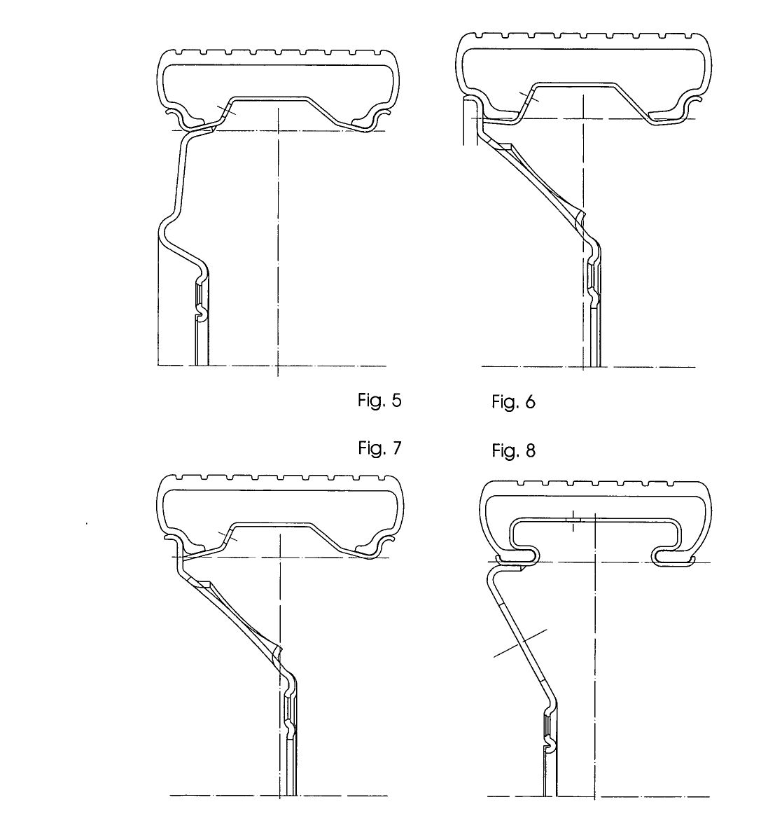

As already mentioned, the rim 2 of the wheel of the present invention has a support ring 5 as an integral part, this ring having the characteristic of being protuberant, so that the maximum diameter D of the thus configured wheel 1, as well as the outer diameter of the rim 2, is equivalent to the outer diameter of the ring 5 (that is to say, the average diameter of the outer surface of the ring 5, the one facing the tire 4). In this way, said diameter D defined by the outer surface of the support ring 5 is greater than the diameter defined by the end portion 20 of the rim 2. Preferably, the cross-section of the rim 2 and, therefore, of the wheel 1, has inverted-M-shaped. However, this cross-section may have any other shapes, as for example a “Ω” or omega shape, which even so will be included in the scope of the invention. Some formats of cross-section may be seen in the illustrations of FIGS. 5-8. The only characteristic which the rim 2 and the wheel 1 should have is a support ring 5 as integral part of the rim 2. Evidently, the wheel 1 may be built by other methods, as already mentioned, and it may have all of these characteristics. The rim 2 may have more than one support ring 5.

Optionally, the support ring 5 may comprise a bore 6 for installation of the tire-inflating control valve (not shown).

Thus, the present invention dispenses with the use of a belt of a deformable material positioned concentrically with the rim (which exists on the wheels of the prior art, described before), thus economizing in the manufacture cost, by saving deformable material (usually an elastomer or polymer), economizing in the step of the productive process of placing the ring of deformable material on the rim, which requires the employ of fixation means for fixing this ring on the rim, as for example adhesives.

When the tire 4 is mounted on the wheel 1 and is inflated, the air pressure itself in its interior 40 maintains it shape. In this situation, there is no contact between the inner surface of the tire 4 and the outer surface of the ring 5. When there is loss of pressure inside 40 the tire 4, the absence of air causes the weight of the vehicle to deform the tire 4, with the consequent folding of its side walls, also known as shoulders 42. In the case of a conventional wheel, without the existence of a support ring 5, the deformation is so great that tire collapses, because of cuts in its shoulders 42 that make it useless, if the driver insists on moving the vehicle. This collapse of the tire is followed by damages to the wheel, since it now touches the ground directly. In addition to the material damages mentioned above, the consequence of this all is the loss of directional control over the vehicle, which may lead to an accident.

In the case of the wheel of the present invention, the support ring 5 props the airless tire 4, causing its side shoulders 42 to present a reduced folding as compared with what would happen if a conventional wheel were used. The inner surface of the tire 4 touches the outer surface of the ring 5 and the result is that it becomes possible to drive the vehicle with total control, without any risk of unexpected loss of control.

Optionally, one can go on driving and only change the tire 4 at a safe place, or else go directly to a tire-fixing workshop, since the present invention enables the vehicle to run normally with the empty tire. One should only take care not to drive at high speeds, in order to avoid excessive heating of the airless tire 4.

A preferred embodiment having been described, it should be understood that the scope of the present invention embraces other possible variations, being limited only by the contents of the accompanying claims, which include the possible equivalents.

1. A vehicle wheel comprising a substantially circular rim for fixedly receiving an inflatable tire, and at least one support ring disposed substantially concentric with the rim and engaged therewith so as to be an integral part thereof, the support ring defining a bore for receiving a tire-inflating control valve.

2. A wheel according to claim 1, wherein an outer surface of the support ring defines a maximum outer diameter of the wheel.

3. A wheel according to claim 2, wherein the maximum outer diameter defined by the outer surface of the support ring is greater than a diameter defined by an end portion of the rim.

4. A wheel according to claim 1, wherein the rim has a substantially inverted M-shaped cross-section.

5. A wheel according to claim 1, wherein the rim has a substantially Ω(Omega)-shaped cross-section.

6. A wheel according to claim 1, wherein the rim is manufactured from laminated steel.

7. A wheel according to claim 1, wherein the wheel is manufactured from at least one of a light metal alloy and carbon steel.

8. A wheel according to claim 1, wherein the wheel comprises more than one support ring.

9. A substantially circular rim for a wheel, the rim being configured to fixedly receive an inflatable tire and comprising at least one support ring disposed substantially concentric with the rim and engaged therewith so as to be an integral part thereof, the support ring defining a bore for receiving a tire-inflating control valve.

10. A rim according to claim 9, wherein an outer surface of the support ring defines a maximum outer diameter of the rim.

11. A rim according to claim 10, wherein the maximum outer diameter defined by the outer surface of the support ring is greater than a diameter defined by an end portion of the rim.

12. A rim according to claim 9, wherein the rim has a substantially inverted M-shaped cross-section.

13. A rim according to claim 9, wherein the rim has a substantially Ω(Omega)-shaped cross-section.

14. A rim according to claim 9, wherein the rim is manufactured from laminated steel.
